(19) United States
(12) Patent Application Publication
(10) Pub. No.: US 2010/0023742 A1
(43) Pub. Date: Jan. 28, 2010

(54) BIOS SHARING SYSTEM IN A HIGH DENSITY SERVER AND METHOD THEREOF

(76) Inventors: Chih-Wei Chen, Taipei City (TW); Hsiao-Fen Lu, Taipei City (TW)

Correspondence Address: BRIAN M. MCINNIS, 12th Floor, Ruttonjee House, 11 Duddell Street, Hong Kong, HK

(21) Appl. No.: 12/251,929

(22) Filed: Oct. 15, 2008

(30) Foreign Application Priority Data
Jul. 22, 2008 (TW) 97127845

(51) Int. Cl. G06F 15/177

(52) U.S. Cl. 713/2

(57) ABSTRACT

A BIOS sharing system in a high density servers includes a plurality of servers, a BIOS (Basic Input Out System), a switch and a micro controller. Each server has a motherboard hardware and a BMC (Baseboard Management Controller), wherein each BMC is operable to output a status order in response to a control information of each motherboard hardware. The BIOS is operable to initialize each motherboard hardware before the motherboard hardware being operating. The switch is interconnected between the BIOS and each server for selectively switching to one of the servers such that the BIOS is loaded to the one of the servers for initializing. The micro controller is interconnected between the switch and each BMC, wherein the micro controller is operable to order the switch for selectively switching to one of the servers in response to the status order.

### RELATED APPLICATIONS

This application claims priority to Taiwan Application Serial Number 97127845, filed Jul. 22, 2008, which is herein incorporated by reference.

### BACKGROUND

1. Field of Invention

The present invention relates to a BIOS sharing system and method thereof. More particularly, the present invention relates to a BIOS sharing system and method in a high density server for high-performance computing.

2. Description of Related Art

A high-density server system is a computing system, which has several independently operable server motherboards housed in one casing, and CPUs, cooling fans and other components on each server motherboard share a common power supply. As all child servers, i.e. server motherboards, are of the same hardware specifications, and each child server has its own BIOS (Basic Input Output System) for self-testing, hardware initializing, loading operation system or the like actions. Because each child server has one independent BIOS, updating every BIOS would be a time-consuming task. Since all child servers are of the same hardware specifications, software or firmware within every BIOS ROM would be useless after the hardware being initialized and thence become redundant.

### SUMMARY

It is therefore an objective of the present invention to provide a BIOS sharing system and method in a high density server.

In accordance with the foregoing and other objectives of the present invention, a BIOS sharing system in a high density servers includes a plurality of servers, a BIOS (Basic Input Out System), a switch and a micro controller. Each server has a motherboard hardware and a BMC (Baseboard Management Controller), wherein each BMC is operable to output a status order in response to a control information of each motherboard hardware. The BIOS is operable to initialize each motherboard hardware before the motherboard hardware being operating. The switch is interconnected between the BIOS and each server for selectively switching to one of the servers such that the BIOS is loaded to the one of the servers for initializing. The micro controller is interconnected between the switch and each BMC, wherein the micro controller is operable to order the switch for selectively switching to one of the servers in response to the status order.

In accordance with the foregoing and other objectives of the present invention, a BIOS sharing method in a high density server includes the following steps: (a) a plurality of servers requesting a micro controller for booting thereof by using a BIOS; (b) judging whether or not the BIOS is being used to boot one of the servers; (c) halting the remaining servers requesting for booting; (d) informing the micro controller after the one of the servers being booted by using the BIOS; (e) judging whether or not one of the remaining servers being halted for booting; and (f) permitting the one of the remaining servers being halted for booting to boot by using the BIOS and informing the micro controller.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a block diagram of a BIOS sharing system in a high density server according to one preferred embodiment of this invention; and

FIG. 2 is a flowchart of a BIOS sharing method in a high density server according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

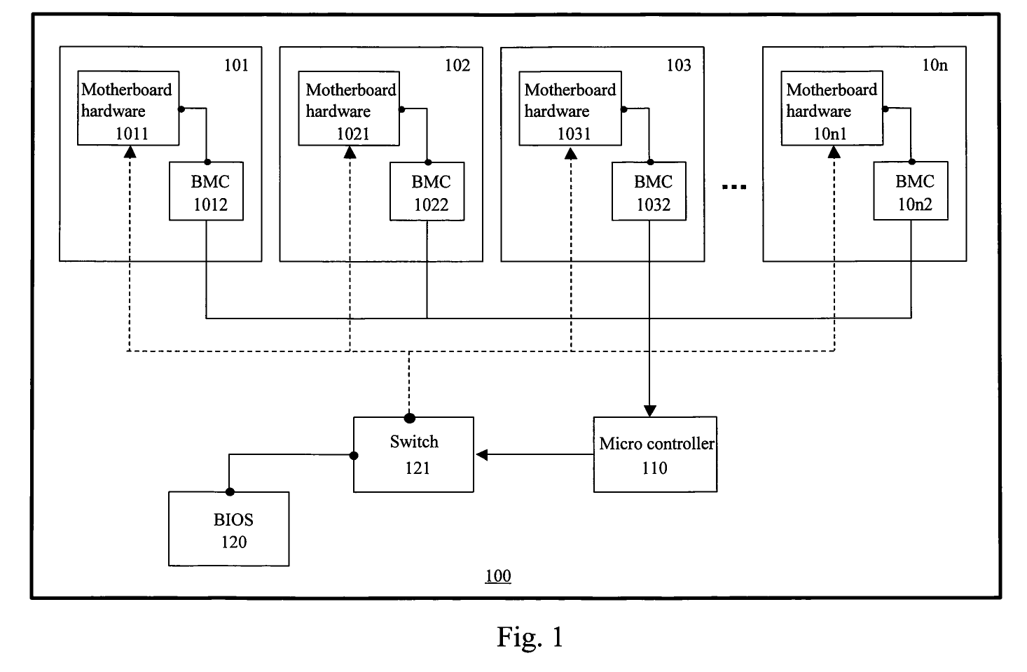

FIG. 1 illustrates a block diagram of a BIOS sharing system in a high density server according to one preferred embodiment of this invention. The BIOS sharing system 100 in a high density server includes multiple servers (101˜10n), a BIOS 120 (a BIOS software stored in a read-only memory) and a micro controller 110. The servers. (101˜10n) are of the same hardware specifications, i.e. same computing capacity and same memory capacity, and operable independently from one another. Each server 10n has a hardware 10n1 and a BMC (Baseboard Management Controller, BMC) 10n2, wherein the motherboard hardware includes all components on the motherboard, which are initialized before being operating. The BMC 10n2 is operable to output a status order in response to a control information of each motherboard hardware 10n1. A switch 121 is interconnected between the BIOS 120 and each motherboard hardware (1011˜10n1) within each server (101˜10n) for selectively switching to one of the servers such that the BIOS 120 can be loaded to the one of the servers for initializing. The BIOS 120 is a software stored in a read-only memory and operable to be loaded into and initialize a motherboard hardware (10n) of a server 10n, and then to call for a operation system, i.e. Windows or Linux. The micro controller 110 is interconnected between the switch 121 and each BMC (1012˜10n2), and operable to order the switch 121 for selectively switching to one of the servers in response to the status order.

The status order is the signal transmitted by an Intelligent Platform Management Bus interconnected between each BMC (1012˜10n2) and the micro controller 110. The status order includes the following types: “the server 10n requesting the BIOS 120 for booting” and “the server 10n being loaded an operation system after being booted by the BIOS 120”. In case the server 101 is of the order status is “the server 101 requesting the BIOS 120 for booting”, the switch 121 is ordered by the micro controller 110 to switch to the server 101 (and its motherboard hardware) to load the BIOS 120. In case the server 101 is of the order status “the server being loaded a operation system after being booted by the BIOS”, the switch 121 is ordered by the micro controller 110 to switch to next server (such as server 102) to load the BIOS 120.

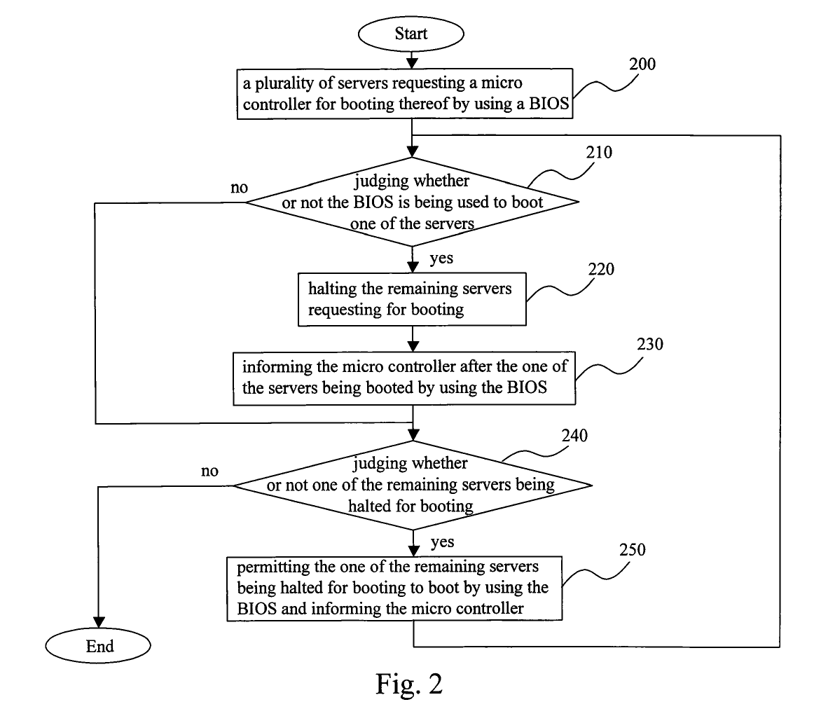

FIG. 2 is a flowchart of a BIOS sharing method in a high density server according to one preferred embodiment of this invention. In step 200, a plurality of servers request (101˜10n) a micro controller 110 for booting thereof by using a BIOS 120. In step 210, the micro controller 110 is operable to judge whether or not the BIOS 120 is being used to boot one of the servers (101˜10n). In step 210, in case the BIOS 120 is being used to boot the server 101, the remaining servers (102˜10n) requesting for booting are halted by the micro controller 110 (step 220). In step 210, in case the BIOS 120 is not being used to boot any server, the procedure goes to step 240. After step 220, the server 101 has been booted by using the BIOS 120 and the micro controller is informed of the result (step 230). In step 240, the micro controller 110 is operable to judge whether or not one of the remaining servers (102˜10n) is halted for booting. In case the remaining servers (102˜10n) is halted for booting, one of remaining servers (such as server 102) is permitted to boot by using the BIOS 120 and the micro controller is informed of the result (step 250). In case there is no server halted for booting in step 240, all the servers (101˜10n) requesting for booting have been booted by using the BIOS 120 and the procedure is ended.

Step 210 and step 240 is executed by the micro controller 110 in response to a status order output by the BMC (1012˜10n2) of the servers (101 10n). The status order is the signal transmitted by an Intelligent Platform Management Bus interconnected between each BMC (1012˜10n2) and the micro controller 110. In addition, step 250 is executed by the switch 121, ordered by the micro controller 110, to switch to one of the remaining servers (such as the server 10n) being halted for booting to load the BIOS 120.

According to discussed embodiments, the present invention provides a BIOS sharing system and method in a high density server, which includes a switch interconnected the only one BIOS and each server and a micro controller to order the switch to selectively switch to one of the servers requesting for booting. Therefore, multiple servers within the high density server can share one common BIOS, which results in a easy and quick way to update the BIOS.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A BIOS sharing system in a high density server, comprising:
a plurality of servers, each server having a motherboard hardware and a BMC (Baseboard Management Controller), wherein each BMC is operable to output a status order in response to a control information of each motherboard hardware;
a BIOS (Basic Input Out System) being operable to initialize each motherboard hardware of each server before the motherboard hardware being operating;
a switch being interconnected between the BIOS and each server for selectively switching to one of the servers such that the BIOS is loaded to the one of the servers for initializing; and
a micro controller being interconnected between the switch and each BMC, the micro controller being operable to order the switch for selectively switching to one of the servers in response to the status order.

2. The BIOS sharing system of claim 1, wherein the BIOS is a software to initialize the motherboard hardware and call for an operation system.

3. The BIOS sharing system of claim 1, wherein the servers are of the same hardware specifications.

4. The BIOS sharing system of claim 1, wherein the servers are operable independently from one another.

5. The BIOS sharing system of claim 1, wherein the order status is the signal transmitted by an Intelligent Platform Management Bus interconnected between the BMC and the micro controller.

6. The BIOS sharing system of claim 1, wherein the order status comprises the server requesting the BIOS for booting, and the server being loaded an operation system after being booted by the BIOS.

7. The BIOS sharing system of claim 6, wherein when one of the servers is of the order status is “the server requesting the BIOS for booting”, the switch being ordered by the micro controller to switch to the one of the servers to load the BIOS.

8. The BIOS sharing system of claim 6, wherein when one of the servers is of the order status “the server being loaded a operation system after being booted by the BIOS”, the switch being ordered by the micro controller to switch to next one of the servers to load the BIOS.

9. A BIOS sharing method in a high density server, comprising the following steps:
(a) a plurality of servers requesting a micro controller for booting thereof by using a BIOS;
(b) judging whether or not the BIOS is being used to boot one of the servers;
(c) halting the remaining servers requesting for booting;
(d) informing the micro controller after the one of the servers being booted by using the BIOS;
(e) judging whether or not one of the remaining servers being halted for booting; and
(f) permitting the one of the remaining servers being halted for booting to boot by using the BIOS and informing the micro controller.

10. The BIOS sharing method of claim 9, wherein the BIOS is a software to initialize the motherboard hardware and call for an operation system.

11. The BIOS sharing method of claim 9, wherein the servers are of the same hardware specifications.

12. The BIOS sharing method of claim 9, wherein the servers are operable independently from one another.

13. The BIOS sharing method of claim 9, wherein the step (e) is executed by the micro controller in response to a status order output by a BMC (Baseboard Management Controller).

14. The BIOS sharing method of claim 13, wherein the order status is the signal transmitted by an Intelligent Platform Management Bus interconnected between the BMC and the micro controller.

15. The BIOS sharing method of claim 9, wherein the step (f) is executed by the switch being ordered by the micro controller to switch to one of the remaining servers being halted for booting to load the BIOS.
